(19) United States
(12) Patent Application Publication
(10) Pub. No.: US 2006/0009978 A1
(43) Pub. Date: Jan. 12, 2006

(54) Methods and systems for synthesis of accurate visible speech via transformation of motion capture data

(75) Inventors: Jiyong Ma, Boulder, CO (US); Ronald Cole, Boulder, CO (US); Wayne Ward, Boulder, CO (US); Bryan Pellom, Broomfield, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Regents of the University of Colorado, Boulder, CO (US)

(21) Appl. No.: 11/173,921

(22) Filed: Jul. 1, 2005

Related U.S. Application Data
(60) Provisional application No. 60/585,484, filed on Jul. 2, 2004.

(51) Int. Cl. G10L 13/06

(52) U.S. Cl. 704/266

(57) ABSTRACT

The disclosure describes methods for synthesis of accurate visible speech using transformations of motion-capture data. Methods are provided for synthesis of visible speech in a three-dimensional face. A sequence of visemes, each associated with one or more phonemes, are mapped onto a three-dimensional target face, and concatentated. The sequence may include divisemes corresponding to pairwise sequences of phonemes, wherein the diviseme is comprised of motion trajectories of a set facial points. The sequence may also include multi-units corresponding to words and sequences of words. Various techniques involving mapping and concatenation are also addressed.

### CROSS-REFERENCE TO RELATED APPLICATIONS

The present application claims priority to U.S. Provisional Patent Application No. 60/585,484, “Methods and Systems for Synthesis of Accurate Visible Speech via Transformation of Motion Capture Data,” filed Jul. 2, 2004, the disclosure (including Appendices I and II) of which is incorporated herein in its entirety for all purposes. This application is also related to U.S. patent application Ser. No. __/___,___, Attorney Docket No. 40281.12USU1, Client/Matter No. CU1173B, “Virtual Character Tutor Interface and Management,” filed Apr. 18, 2005, which claims priority from U.S. Provisional Patent Application No. 60/563,210, “Virtual Tutor Interface and Management,” filed Apr. 16, 2004, the disclosures of each Application are incorporated herein in their entirety for all purposes.

### STATEMENT AS TO RIGHTS TO INVENTIONS MADE UNDER FEDERALLY SPONSORED RESEARCH AND DEVELOPMENT

This Government has rights in this invention pursuant to NSF CARE grant EIA-9996075; NSF/ITR grant IIS-0086107; NSF/ITR Grant REC-0115419; NSF/IERI (Interagency Education Research Initiative) Grant EIA-0121201 and NSF/IERI Grant 1R01HD-44276.01.

### BACKGROUND OF THE INVENTION

This application relates generally to visible speech synthesis. More specifically, this application relates to methods and systems for synthesis of accurate visible speech via transformation of motion capture data.

Spoken language is bimodal in nature: auditory and visual. Between them, visual speech can complement auditory speech understanding in noisy conditions. For instance, most hearing-impaired people and foreign language learners heavily rely on visual cues to enhance speech understanding. In addition, facial expressions and lip motions are also essential to sign language understanding. Without facial information, sign language understanding level becomes very low. Therefore, creating a 3D character that can automatically produce accurate visual speech synchronized with auditory speech will be at least beneficial to language understanding when direct face-to-face communication is impossible.

Researchers in the past three decades have shown that visual cues in spoken language can augment auditory speech understanding, especially in noisy environment. However, automatically producing accurate visible speech and realistic facial expressions for 3D computer character seems to be a nontrivial task. The reasons include: 3D lip motions are not easy to control and the coarticulation in visible speech is difficult to model.

Researchers have devoted considerable efforts to creating convincing 3D face animation. The approaches include: parametric-based, physics-based, image-based, performance-driven approach, and multitarget morphing. Although these approaches have enriched 3D face animation theory and practice, creating convincing visible speech is still a time consuming task. To create only a short scenario of 3D facial animation in movies, it will take a skilled animator several hours of repeatedly modifying animation parameters to get the desired animation effect. Although some 3D design authoring tools such as 3Ds MAX or MAYA are available for animators, they cannot automatically generate accurate visible speech, and these tools require repeatedly adjusting and testing to achieve more optimal animation parameters for visible speech, which is a tedious task.

In the physics-based approach, a muscle is usually connected to a group of vertices. This requires animators to manually define which vertex is associated with which muscle and to manually put muscles under the skin surface. Muscle parameters are manually modified by trial and error. These tasks are tedious and time consuming. It seems that no unique parameterization approach has proven to be sufficient to create face expressions and viseme targets with simple and intuitive controls. In addition, it is difficult to map muscle parameters estimated from the motion capture data to a 3D face model. To simplify the physics-based approach, one proposal has used the concept of abstract muscle procedure. One challenging problem in physics-based approaches is how to automatically get muscle parameters. Inverse dynamics approaches that use advanced measurement equipment may provide a scientific solution to the problem of obtaining facial muscle parameters.

The image-based approach aims at learning face models from a set of 2D images instead of directly modeling 3D face models. One typical image-based animation system called Video Rewrite uses a set of triphone segments is used to model the coarticulation in visible speech. For speech animation, the phonetic information in the audio signal provides cues to locate its corresponding video clip. In the approach, the visible speech is constructed by concatenating the appropriate visual triphone sequences from a database. An alternative approach analogous to speech synthesis has also been proposed in which the visible speech synthesis is performed by searching a best path in the triphone database using Viterbi algorithm. However, experimental results show that when the lip space is not populated densely, the animations produced may be jerky. Recently, another approach has adopted machine learning and computer vision techniques to synthesize visible speech from recorded video. In that system, a visual speech model is learned from the video data that is capable of synthesizing the human subject's lip motion not recorded in the original speech. The system can produce intelligible visible speech. The approach has two limitations: 1) the face model is not 3D; 2) the face appearance cannot be changed.

In a performance-driven approach, a motion capture system is employed to record motions of a subject's face. The captured data from the subject are retargeted to a 3D face model. The captured data may be 2D or 3D positions of feature points on the subject's face. Most previous research on performance-driven facial animation requires the face shape of the subject to be closely resembled by the target 3D face model. When the target 3D face model is sufficiently different to that of the captured face, face adaptation is required to retarget the motions. In order to map motions, global and local face parameter adaptation can be applied. Before motion mapping, the correspondences between key vertices in the 3D face model and the subject's face are manually labeled. Moreover, local adaptation is required for the eye, nose, and mouth zones. However, this approach is not sufficient to describe complex facial expressions and lip motions. One approach that has been proposed is to create facial animation using motion capture data and shape blending interpolation. Here, computer vision is utilized to track the facial features in 2D while shape-blending interpolation is proposed to retarget the source motion. Another approach that has been proposed is to transfer vertex motion from a source face model to a target model. It is claimed that with the aid of an automatic heuristic correspondence search, the approach requires a user to select fewer than ten points in the model. In addition, a system has been created for capturing both the 3D geometry and color shading information for human facial expression. Another approach used motion capture techniques to get facial description parameters and facial animation parameters defined in MPEG4 face animation standard. Recently, a technique has been developed to track the motion from animated cartoons and retarget it on 3-D models.

There thus remains a general need in the art for improved methods and systems for synthesis of accurate visible speech.

### BRIEF SUMMARY OF THE INVENTION

Embodiments of the invention thus provide methods for synthesis of accurate visible speech using transformations of motion-capture data. In one set of embodiments, a method is provided for synthesis of visible speech in a three-dimensional face. A sequence of visemes is extracted from a database. Each viseme is associated with one or more phonemes, and comprises a set of noncoplanar points defining a visual position on a face. The extracted visemes are mapped onto the three-dimensional target face, and concatentated.

In some such embodiments, the visemes may be comprised of previously captured three-dimensional visual motion-capture points from a reference face. In some embodiments, these motion capture points are mapped to vertices of polygons of the target face. In other embodiments, the sequence includes divisemes corresponding to pairwise sequences of phonemes, wherein the diviseme is comprised of motion trajectories of the set of noncoplanar points. In some instances, a mapping function utilizing shape blending coefficients is used. In other instances, the sequences of visemes are concatenated using a motion vector blending function, or by finding an optimal path through a directed graph. Also, the transition may be smoothed, using a spline algorithm in some instances. The visual positions may include a tongue, and coarticulation modeling of the tongue may be used as well. In different embodiments, the sequence includes multi-units corresponding to words and sequences of words, wherein the multi-units are comprised of sets of motion trajectories of the set of noncoplanar points. The methods of the present invention may also be embodied in a computer-readable storage medium having a computer-readable program embodied therein.

In another set of embodiments, an alternative method is provided for synthesis of visible speech in a three-dimensional face. A plurality of sets of vectors is extracted from a database. Each set is associated with a sequence of phonemes, and corresponds to the movement of a set of noncoplanar points defining a visual position on a face. The set of vectors are mapped onto the three-dimensional target face, and concatentated. According to one embodiment, each vector corresponds to visual motion-capture points from a reference face. In some instances, the sets of vectors are concatenated using a motion vector blending function, or by finding an optimal path through a directed graph. In other instances, the transition between sets of vectors may be smoothed.

### BRIEF DESCRIPTION OF THE DRAWINGS

A further understanding of the nature and advantages of the present invention may be realized by reference to the remaining portions of the specification and the drawings.

FIG. 1 is a schematic illustration providing an overview of a system in accordance with one embodiment of the invention;

FIG. 2 provides an illustration of lip shapes in viseme transition motions;

FIG. 3 provides an illustration of a motion capture system used in embodiments of the invention by showing captured images;

FIG. 4 provides an illustration of facial reconstruction from images captured by the motion capture system;

FIG. 5 provides an illustration of lip shapes for visemes based on images captured by the motion capture system;

FIG. 6 provides an illustration of different visemes designed for Gurney's model;

FIG. 7 provides a graph of concatenating visible speech units according to the Viterbi search algorithm;

FIG. 8 provides a pictorial illustration of synchronization between audio and video signals used in embodiments of the invention;

FIG. 9 provides a schematic illustration of synchronization of animation frame rates used in embodiments of the invention;

FIG. 10 provides side and top views of a three-dimensional tongue model used in embodiments of the invention;

FIG. 11 provides a side-view illustration of exemplary tongue movements;

FIG. 12 provides illustrations of three-dimensional models used in model adaptation of multi-unit embodiments;

FIG. 13 provides an illustration of normalized parameters that may be used in an objective evaluation of the quality of synthesized visible speech in one embodiment;

FIG. 14 provides an illustration of the effect of differences in regularization parameters;

FIG. 15 shows the results of lip-parameter curves in experiments performed to evaluate the quality of synthesized visible speech; and

FIG. 16 provides a comparison of lip-width curves generated by original motion capture data and in different models.

### DETAILED DESCRIPTION OF THE INVENTION

1. Overview

Animating accurate visible speech is useful in face animation because of its many practical applications, ranging from language training for the hearing impaired, to films and game productions, animated agents for human computer interaction, virtual avatars, model-based image coding in MPEG4, and electronic commerce, among a variety of other applications. Embodiments of the invention make use of motion-capture technologies to synthesize accurate visible speech. Facial movements are recorded from real actors and mapped to three-dimensional face models by executing tasks that include motion capture, motion mapping, and motion concatenation.

In motion capture, a set of three-dimensional markers is glued onto a human face. The subject then produces a set of words that cover important lip-transition motions from one viseme to another. In one embodiment discussed in detail below, sixteen visemes are used, but the invention is not limited to any particular number of visemes. The motion-capture system in one embodiment comprises two mirrors and a camcorder, which records video and audio signals synchronously. The audio signal is used to segment video clips so that the motion image sequence for each diviseme is segmented. Computer-vision techniques such as camera calibration, two-dimensional facial-marker tracking, and/or head-pose estimation algorithms may also be implemented in some embodiments. The head pose is applied to eliminate the influence of head motions on the facial markers' movement so that the reconstructed three-dimensional facial-marker positions are substantially invariant to the head pose.

Motion mapping may be useful because the source face is generally different from the target face. In such embodiments, a mapping function is learned from a set of training examples of visemes selected from the source face and designed for the target face. Visemes for the source face are subjectively selected from the recorded images, while visemes for the target three-dimensional face are manually designed according to their appearances in the source face. Preferably, they visually resemble those for the source face. For instance, a viseme that models the /aa/ sound for the source face is preferably very similar visually to the same viseme for the target three-dimensional face. After the motions are mapped from the source face to the target face, a motion concatenation technique may be applied to synthesize natural visible speech. The concatenated objects discussed herein generally comprise three-dimensional trajectories of lip motions.

Embodiments of the invention may be applied to a variety of different three-dimensional face models, including photorealistic and cartoonlike models. In addition, in one embodiment the Festival speech synthesis system may be integrated into an animation engine, allowing extraction of relevant phonetic and timing information of input text by converting the text to speech. In another embodiment, the SONIC speech-recognition engine may be used to force-align and segment prerecorded speech, i.e. to provide timing between the input speech and associated text and/or phoneme sequence. Such a speech synthesizer and forced-alignment system allow analyses to be performed with a variety of input text and speech wave files.

2. System Architecture

Embodiments of the invention use motion-capture techniques to obtain the trajectories of the three-dimensional facial feature points on a subject's face while the subject is speaking. Then, the trajectories of the three-dimensional facial feature points are mapped to make the target three-dimensional face imitate the lip motion. Unlike image-based methods, embodiments of the invention capture motions of three-dimensional facial feature points, map them onto a three-dimensional face model, and concatenate motions to get natural visible speech. This allows motion mapping to be applicable generally to any two-dimensional/three-dimensional character model.

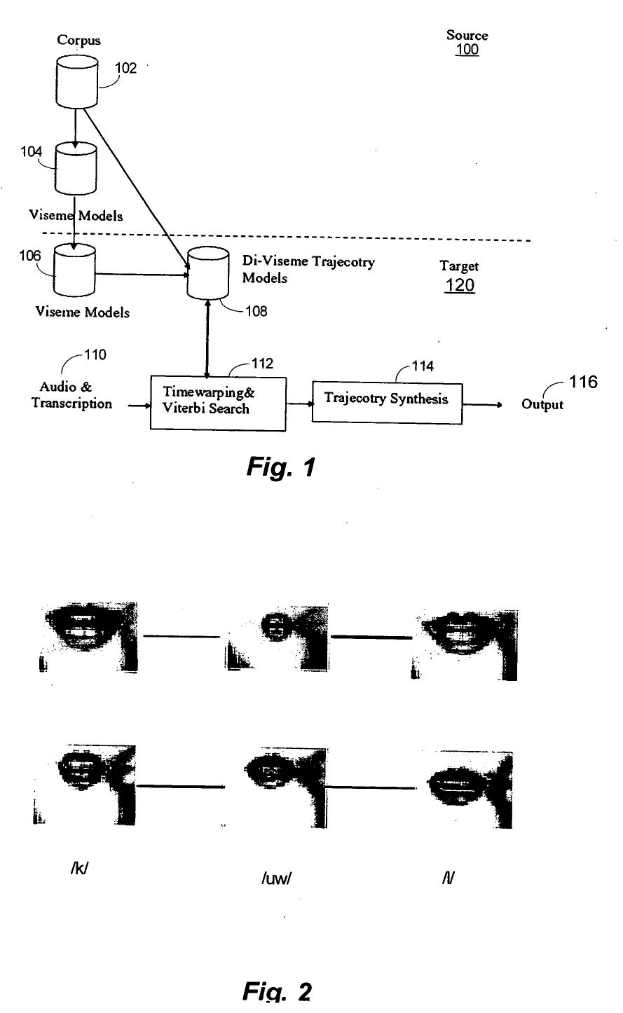

FIG. 1 provides an overview of a system architecture used in one embodiment of the invention for accurate visible speech synthesis. The source is denoted generally by reference numeral 100 and the target by reference numeral 120. The corpus 102 comprises a set of primitive motion trajectories of three-dimensional facial markers reconstructed by a motion-capture system. A set of viseme images in the source face is subjectively selected, and their corresponding three-dimensional facial marker positions constitute the viseme models 104 in the source face. The viseme models 106 in the target three-dimensional face are designed manually to enable each viseme model in the target face to resemble that in the source face. Mapping functions are learned by the viseme examples in the source and target faces. For each diviseme, its motion trajectory is computed with the motion-capture data and the viseme models 106 for the target face to produce di-viseme trajectory models 108. When text is input to the system a phonetic transcription of words is generated by a speech synthesizer 110 that also produces a speech waveform corresponding to the text. If the text is spoken by a human voice, a speech recognition system is used in forced-alignment mode to provide the time-aligned phonetic transcription. Time warping is then applied with a time-warping module 112 to the diviseme motion trajectories 108 so that their time information conforms to the time requirements of the generated phonetic information. The Viterbi algorithm may be applied in one embodiment to find a concatenation path in the space of the diviseme instances. After trajectory synthesis 114, the output 116 comprises visible speech synchronized with auditory speech signals.

3. Visible Speech Synthesis

a. Visible Speech: As used herein, “visible speech” refers generally to the movements of the lips, tongue, and lower face during speech production by humans. According to the similarity measurement of acoustic signals, a “phoneme” is the smallest identifiable unit in speech, while a “viseme” is a particular configuration of the lips, tongue, and lower face for a group of phonemes with similar visual outcomes. A “viseme” is thus an identifiable unit in visible speech. In many languages, there may be many phonemes with visual ambiguity. For example, in English the phonemes /p/, /b/, and /m/ appear visually the same. These phonemes are thus grouped into the same viseme class. Phonemes /p/, /b/, and /m/, as well as /th/ and /dh/ are considered to be universally recognized visemes, but other phonemes are not universally recognized across languages because of variations of lip shapes in different individuals. From a statistical point of view, a viseme may be considered to correspond to a random vector because a viseme observed at different times or under different phonetic contexts may vary in its appearances.

Embodiments of the invention exploit the fact that the complete set of mouth shapes associated with human speech may be reasonably approximated by a linear combination of a set of visemes. For purposes of illustration, some specific embodiments described below use a basis set having sixteen visemes chosen from images of a human subject, but the invention is not intended to be limited to any specific size for the basis set. Each viseme image was chosen at a point at which the mouth shape was judged to be at its extreme shape, with phonemes that look alike visually falling into the same viseme category. This classification was done in a subjective manner, by comparing the viseme images visually to assess their similarity. The three-dimensional feature points for each viseme are reconstructed by the motion-capture system. When synthesizing visible speech from text, each phoneme is mapped to a viseme to produce the visible speech. This ensures a unique viseme target is associated with each phoneme. Sequences of nonsense words that contain all possible motion transitions from one viseme to another may be recorded. After the whole corpus 102 has been recorded and digitized, the three-dimensional facial feature points may be reconstructed. Moreover, the motion trajectory of each diviseme may conveniently be used as an instance of each diviseme. In some embodiments, special treatment may be provided for diphthongs. Since a diphthong, such as /ay/ in “pie” consists of two vowels with a transition between them, i.e. /aa/ /iy/, the diphthong transition may be visually simulated by a diviseme corresponding to the two vowels.

The mapping from phonemes to visemes is many-to-one, such as in cases where two phonemes are visually identical, but differ only in sound, e.g. the set of phonemes /p/, /b/, and /m/. Conversely the mapping from visemes to phonemes may be one-to-many: one phoneme may have different mouth shapes because of the coarticulation effect, which relates to the observation that a speech segment is influenced by its neighboring speech segments during speech production. The coarticulation effect from a phoneme's adjacent two phonemes is referred to as the “primary coarticulation effect” of the phoneme. The coarticulation effect from a phoneme's two second-nearest-neighbor phonemes is called the “secondary coarticulation effect.” Coarticulation enables people to pronounce speech in a smooth, rapid, and relatively effortless manner.

Consideration of the contribution of a phoneme to visible speech perception may be made in terms of invisible phonemes, protected phonemes, and normal phonemes. The term “invisible phoneme” is used herein to describe a phoneme in which the corresponding mouth shape is dominated by its following vowel, such as the first segment in “car,” “golf,” “two,” and “tea.” The invisible phonemes include the phonemes /t, /d/, /g, /h/, and /k/. In some embodiments, lip shapes of invisible phonemes are directly modeled by motion-capture data so that this type of primary coarticulation from the adjacent two phonemes is well modeled. The term “protected phoneme” is used herein to describe phonemes whose mouth shape must be preserved in visible speech synthesis to ensure accurate lip motion. Examples of these phonemes include /m/, /b/, and /p/, as in “man,” “ban,” and “pan,” as well as /p/ and /f/, as in “fan” and “van.”

In embodiments of the invention, motions of three-dimensional facial feature points for diphones/divisemes are directly concatenated. This is illustrated, for example, with the lip shapes shown in FIG. 2 for the English word “cool,” which has a phonetic transcription of /kuwl/. The divisemes in this word are /k-uw/, /uw-l/. Synthesis of the visible speech of the word may be performed by concatenating the two motion sequences in motion-capture data. In particular, the top panels of FIG. 2 depict three visemes in the word “cool,” while the lower panels depict the actual three key frames of lip shapes mapping from the source face in one motion-capture sequence. Embodiments of the invention model the visual transition from one phoneme to another directly from motion-capture data, which is encoded for diphones as parameterized trajectories. Because the tongue movement is not directly measured with the motion-capture system, a special method is used in some embodiments to treat the coarticulation effect of the tongue.

b. Motion Capture: The motion-capture methods and systems used in embodiments of the invention are based on optical capture. Reflective dots are affixed onto the human face, such as by gluing; typical positions for the reflective dots include eyebrows, the outer contour of the lips, the cheeks, and the chin, although the invention is not limited by the specific choice of dot positions. In one embodiment, the motion-capture system comprises a camcorder, a plurality of mirrors, and thirty-one facial markers in green and blue, although the invention is not intended to be limited to such a motion-capture system and other suitable systems will be evident to those of skill in the art after reading this disclosure. For example, different types of devices may be used to record visual and acoustic data, different optical components may be used to obtain different views, and different numbers and/or colors of facial markers may be used. In one embodiment, the video format used by the camcorder is NTSC with a frame rate of 29.97 frames/sec, although other video formats may be used in alternative embodiments.

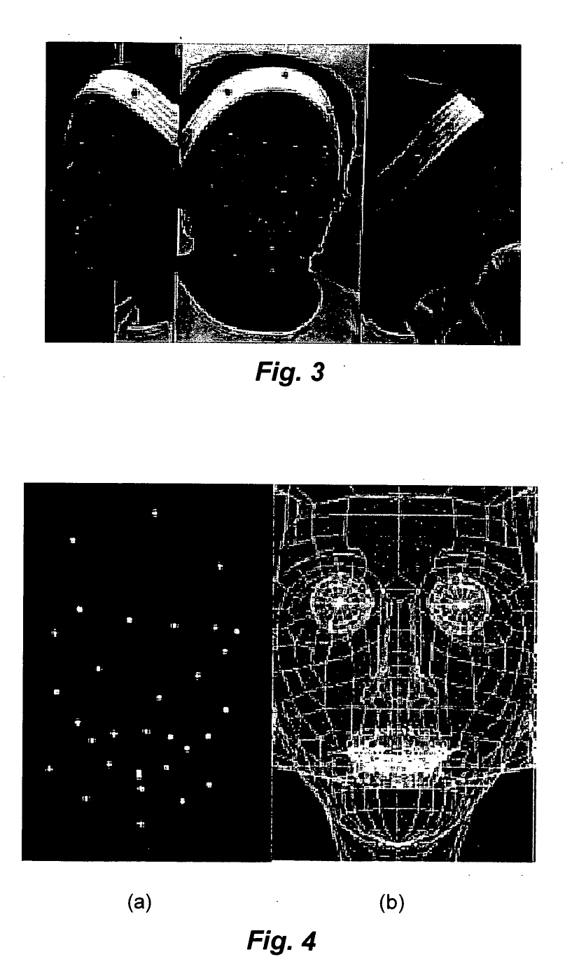

FIG. 3 provides an example of images captured by the motion-capture system at one instant in time, showing two side views and a front view of a subject because of the positioning of the plurality of mirrors. The system uses a facial-marker tracking system to track the motion of the reflective dots automatically, together with a system that provides camera calibration. The observed two-dimensional trajectories at two views are used to reconstruct the three-dimensional positions of facial markers as illustrated in part (a) of FIG. 4. In some embodiments, a head-pose estimation algorithm is used to estimate the subject's head poses at different times. Part (b) of FIG. 4 shows a corresponding Gurney's three-dimensional face mesh.

A visual corpus of the subject speaking a set of words, which may comprise nonsense words, is recorded. The words in the corpus are preferably chosen so that each word visually instantiates motion transition from one viseme to another in the language being studied. For example, with the sixteen visemes studied in the exemplary embodiment for American English, the following mapping from phonemes to visemes was used (including a neutral expression, no. 17):

TABLE I
Mapping from phonemes to visemes

| | |
|---|---|
| 1 | /i:/ week ; /I_x/ roses |
| 2 | /I/ visual; /&/ above |
| 3 | /9r/ read; /&r/ butter ; /3r/ bird |
| 4 | /U/ book; /oU/ boat |
| 5 | /ei/ stable; /@/ bat; /\hat{ }/ above; /E/ bet |
| 6 | /A/ father; />/ caught; /aU/ about; />i/ boy |
| 7 | /ai/ tiger |
| 8 | /T/ think; /D/ thy |
| 9 | /S/ she; /tS/ church; /dZ/ judge; /Z/ azure |
| 10 | /w/ wish; /u/ boot |
| 11 | /s/ sat; /z/ resign |
| 12 | /k/ can; /g/ gap; /h/ high; /N/ sing; /j/ yes |
| 13 | /d/ debt |
| 14 | /v/ vice; /f/ five |
| 15 | /l/ like; /n/ knee |
| 16 | /m/ map; /b/ bet; /p/ pat |
| 17 | /sil/ neutral expression |

Generally, an increase number of modeled visemes is expected to lead to more accurate synthetic visibl speech. The motions of a diviseme represent the motion transition from the approximate midpoint of one viseme to the approximate midpoint of an adjacent viseme, as illustrated previously with FIG. 2. In one embodiment, speech-recognition system operating in forced-alignment mode is used to segment the diviseme speech segment, i.e. in such an embodiment, the speech recognizer is used to determine the time location between phonemes and to find the resulting diviseme timing information. Each segmented video clip contained a sequence of images spanning the duration of the two complete phonemes corresponding to one diviseme. The following is an exemplary diviseme text corpus used for speech synthesis based on diphone modeling, in which the phonetic symbols used are defined in the following words: /i:/ week; /I/ visual; /9r/ read; /U/ book; /ei/ stable; /A/ father; /ai/ tiger; /T/ think; /S/ she; /w/ wish.:
0. i:-w(dee-wet)1. i:-9r(dee-rada)2. i:-U(bee-ood)3. i:-ei(bee-ady) 4. i:-A(bee-ody) 5. i:-aI(bee-idy) 6. i:-T(deeth) 7. i:-S(deesh) 8. i:-k(deeck) 9. i:-l(deela) 10. i:-s(reset) 11. i:-d(deed) 12. i:-I(bee-id) 13. i:-v(deev) 14. i:-m(deem) 15. w-i:(weed) 16. w-9r(duw-rud) 17. u-U(boo-ood) 18. w-ei(wady) 19. u-A(boo-ody) 20. w-aI(widy) 21. u-T(dooth) 22. u-S(doosh) 23. u-k(doock) 24. u-l(doola) 25. u-s(doos) 26. u-d(doo-de) 27. u-l(boo-id) 28. u-v(doov) 29. u-m(doom)30. 9r-i:(far-eed) 31. 9r-u(far-oodles) 32. 9r-U(far-ood) 33. 9r-ei(far-ady) 34. 9r-A(far-ody) 35. 9r-aI(far-idy) 36. 9r-T(dur-thud) 37. 9r-S(durshud) 38. 9r-k(dur-kud) 39. 9r-l(dur-lud) 40. 9r-s(dur-sud) 41. 9r-d(dur-dud) 42. 9r-I(far-id) 43. 9rv(dur-vud) 44. 9r-m(dur-mud) 45. U-i(boo-eat) 46. U-w(boo-wet) 47. U-9r(boor) 48. U-ei(boo-able) 49. U-a(boo-art) 50. U-aI(boo-eye) 51. U-T(booth) 52. U-S(bushes) 53. U-k(book) 54. U-l(pulley) 55. U-s(pussy) 56. U-d(wooded) 57. U-I(boo-it) 58. U-v(booves) 59. U-m(woman) 60. ei-i:(bay-eed)61. ei-w(day-wet) 62. ei-9r(dayrada) 63. ei-U(bay-ood) 64. ei-A(bay-ody) 65. ei-aI(bay-idy) 66. ei-T(dayth) 67. ei-S(daysh) 68. ei-k(dayck) 69. ei-l(dayla) 70. ei-s(days) 71. ei-d(dayd) 72. ei-I(bay-id) 73. eiv(dayv) 74. ei-m(daym) 75. A-i:(bay-idy) 76. A-w(da-wet) 77. A-9r(da-rada) 78. A-U(ba-ood) 79. Aei(ba-ady) 80. A-aI(ba-idy) 81. A-T(ba-the) 82. A-S(dosh) 83. A-k(dock) 84. A-l(dola) 85. As(velocity) 86. A-d(dod) 87. A-I(ba-id) 88. A-v(dov) 89. A-m(dom) 90. aI-i:(buy-eed) 91. aI-w(die-wet) 92. aI-9r(die-rada) 93. aI-U(buy-ood) 94. aI-ei(buy-ady) 95. aI-A(buy-ody) 96. aI-T(die-thagain) 97. aI-S(die-shagain) 98. al-k(die-kagain) 99. aI-l(die-la) 100. aI-s(die-sagain) 101. aI-d(die-dagain) 102. aI-I(buy-id) 103. aI-v(die-vagain) 104. aI-m(die-magain) 105. T-i:(theed) 106. T-w(duth-wud) 107. T-9r(duth-rud) 108. T-U(thook) 109. T-ei(thady) 110. T-A(thody) 111. T-aI(thidy) 112. T-S(duth-shud) 113. T-k(duth-kud) 114. T-l(duth-lud) 115. T-s(duth-sud) 116. T-d(duth-dud) 117. T-I(thid) 118. Tv(duth-vud) 119. T-m(duth-mud) 120. S-i:(sheed) 121. S-w(dush-wud) 122. S-9r(dush-rud) 123. SU(shook) 124. S-ei(shady) 125. S-A(shody) 126. S-aI(shidy) 127. S-T(dush-thud) 128. S-k(dush-kud) 129. S-l(dush-lud) 130. S-s(dush-sud) 131. S-d(dush-dud) 132. S-I(shid) 133. S-v(dush-vud) 134. Sm(dush-mud) 135. k-i:(keed) 136. k-w(duk-wud) 137. k-9r(duk-rud) 138. k-U(kook) 139. k-ei(backady) 140. k-A(kody) 141. k-aI(kidy)142. k-T(duk-thud) 143. k-S(duk-shud) 144. k-l(duk-lud) 145. ks(duk-sud) 146. k-d(duk-dud) 147. k-I(kid) 148. k-v(duk-vud) 149. k-m(duk-mud)150. 1-i:(leed) 151. lw(dul-wud) 152. l-9r(dul-rud) 153. l-U(fall-ood) 154. l-ei(fall-ady) 155. l-A(fall-ody) 156. l-aI(fall-idy) 157. l-T(dul-thud) 158. l-S(dul-shud) 159. l-k(dul-kud) 160. l-s(dul-sud) 161. l-d(dul-dud) 162. l-I(fallid) 163. l-v(dul-vud) 164. l-m(dul-mud) 165. s-i:(seed) 166. s-w(dus-wud) 167. s-9r(dus-rud) 168. s-U(sook) 169. s-ei(sady) 170. s-A(sody) 171. s-aI(sidy) 172. s-T(dus-thud) 173. s-S(dus-shud) 174. sk(dus-kud) 175. s-l(dus-lud) 176. s-d(dus-dud) 177. s-I(sid) 178. s-v(dus-vud) 179. s-m(dus-mud) 180. d-i:(deed) 181. d-w(dud-wud) 182. d-9r(dud-rud) 183. d-U(dook) 184. d-ei(dady) 185. d-A(dody) 186. d-aI(didy) 187. d-T(dud-thud) 188. d-S(dud-shud) 189. d-k(dud-kud) 190. d-l(dud-lud) 191. d-s(dudsud) 192. d-I(did) 193. d-v(dud-vud) 194. d-m(dud-mud) 195. I-i:(ci-eed) 196. I-w(ci-wet) 197. I-9r(cirada) 198. I-U(ci-ood) 199. I-ei(ci-ady) 200. I-A(ci-ody) 201. I-aI(ci-idy) 202. I-T(dith) 203. I-S(dish) 204. I-k(dick) 205. I-l(dill) 206. I-s(dis) 207. I-d(did) 208. I-v(div) 209. I-m(dim) 210. v-i:(veed ) 211. v-w(duv-wud) 212. v-9r(duv-rud) 213. v-U(vook) 214. v-ei(vady) 215. v-A(vody) 216. v-aI(vidy) 217. v-T(duv-thud) 218. v-S(duv-shud) 219. v-k(duv-kud) 220. v-l(duv-lud) 221. v-s(duv-sud) 222. vd(duv-dud) 223. v-I(vid) 224. v-m(duv-mud) 225. m-i:(meed) 226. m-w(dum-wud) 227. m-9r(dum-rud) 228. m-U(mook) 229. m-ei(mady) 230. m-A(monic) 231. m-aI(midy) 232. m-T(dum-thud) 233. m-S(dum-shud) 234. m-k(dum-kud) 235. m-l(dum-lud) 236. m-s(dum-sud) 237. m-d(dum-dud) 238. m-I(mid) 239. m-v(dum-vud).
   Videos and utterances using this technique may be viewed at the following website: http://cslr.colorado.edu/˜jiyong/corpus.html.

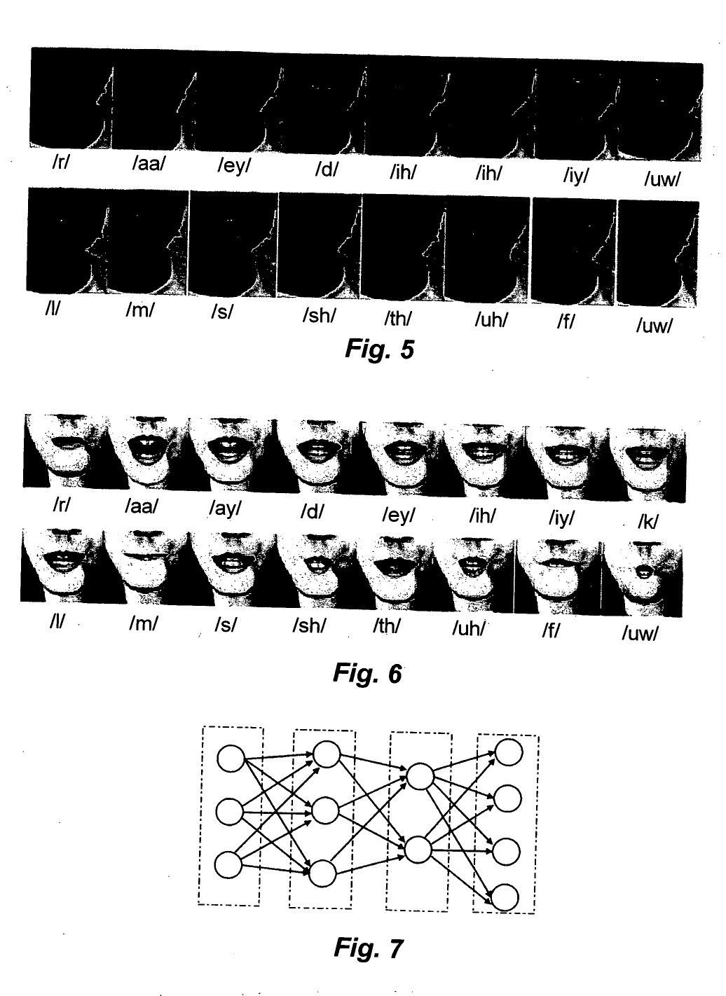

c. Linear Viseme Space: As shown in FIG. 4, the reconstructed facial feature points may be sparse, even while the vertices in the three-dimensional mesh of a face model are dense, indicating that many vertices in the three-dimensional face model have no corresponding points in the set of the reconstructed three-dimensional facial feature points. However, movements of vertices in the three-dimensional facial model may have certain correlations resulting from the physical constraints of facial muscles. Embodiments of the invention allow the movement correlation among the vertices in the three-dimensional face model to be estimated with a set of viseme targets manually designed for the three-dimensional face model to provide learning examples. This set of viseme targets may then be sed as training examples in such embodiments to learn a mapping from the set of three-dimensional facial feature points in the source face to the set of vertices in the target three-dimensional face model. For instance, as shown in FIGS. 5 and 6 for the exemplary embodiment, there are sixteen viseme targets for the source face (FIG. 5) and for the target face (FIG. 6). Each mouth shape in the source face shown in FIG. 5 may be mapped to a corresponding mouth shape in the target face shown in FIG. 6.

Embodiments of the invention thus use a viseme-blending interpolation approach. It is known that a linear combination of a set of images or graph prototypes at different poses or views can efficiently approximate complex objects. Embodiments of the invention permit automatic determination of linear coefficients of a set of visemes to approximate the mouth shape in a lip-motion trajectory. Defining Gᵢ(i=0, 1, 2, . . . , V−1) to be Sᵢ or Tᵢ, where Sᵢ and Tᵢ respectively represent viseme targets for the source face and target face, allows definition of a set of linear subspaces spanned by {Gᵢ}:

$$\{ G \vert G = {\sum }_{i = 0}^{V - 1} {w}_{i} {G}_{i} \} .$$

For the source face, the subspace is thus

$$S = {\sum }_{i = 0}^{V - 1} {w}_{i} {S}_{i} ,$$

and for the target face, the subspace is thus

$$T = {\sum }_{i = 0}^{V - 1} {w}_{i} {T}_{i} ,$$

where the set of weighting coefficients {wᵢ} define linear-combination coefficients or shape-blending coefficients. The goal of the interpolation approach is to find a mapping function f(S) that maps Sᵢ to Tᵢ, i.e. f(Sᵢ)=Tᵢ, with any observation vector S provided by the motion-capture system being mapped to T in the target face that is visually similar with S. Once the coefficients are estimated with the observation data in the source face, the observed vector S is mapped to T. One simple form of mapping function is linear with respect to S, in which case

$$T = f ( S ) = f ( {\sum }_{i = 0}^{V - 1} {w}_{i} {S}_{i} ) = {\sum }_{i = 0}^{V - 1} {w}_{i} f ( {S}_{i} )$$

for any linear function f

If there are N frames of observation vectors S(t), for t=1, 2, . . . , N in one observed motion sequence, then the shape-blending coefficients corresponding to the tth frame are wᵢ(t), i=0, 1, . . . , V−1. The robust shape-blending coefficients may then be estimated by minimizing the following fitting error:

$${min}_{w} {\sum }_{i = 1}^{N} ( {‖ S ( t ) = {\sum }_{i = 0}^{V - 1} {w}_{i} ( t ) {S}_{i} ‖}^{2} + λ {\sum }_{i = 0}^{V - 1} {w}_{i}^{2} ( t ) + γ {\sum }_{i = 1}^{V - 1} ( {w}_{i} ( t + 1 ) - 2 {w}_{i} ( t ) + {{w}_{i} ( t - 1 )}^{2} ) ) ,$$

with the following constraints:
lᵢ≦wᵢ(t)≦hᵢ;

$${\sum }_{i = 0}^{V - 1} {w}_{i} ( t ) = 1 ;$$

wᵢ(0)=2wᵢ(1)−wᵢ(2);
wᵢ(N+1)=2wᵢ(N)−wᵢ(N−1); and
the constraint that the sum of the shape-blending coefficients be one to minimize expansion or shrinkage on the polygon meshes when the mapping function is applied. In this expressions, lᵢ=−εᵢ and h=1+δ, where εᵢ and δᵢ are small positive parameters so that more robust and more accurate shape-blending coefficients may be estimated by solving the optimization problem; where w={w(t)}ₜ₌₁^{N} and

$$w ( t ) = {\{ {w}_{i} ( t ) \}}_{i = 0}^{V - 1} ;$$

and where λ is a positive regularization parameter to control the amplitude of the shape-blending coefficients and γ is a positive regularization parameter to control the smoothness of the trajectory of the shape-bending coefficients. The optimization problem in this specific embodiment involves convex quadratic programming in which the objective function is a convex quadratic function and the constraints are linear. One method for solving this optimization problem is the primal-dual interior-point algorithm, such as described in Gertz E M and Wright S J, “Object-oriented software for quadratic programming,” ACM Transactions on Mathematical Software, 29, 58-81 (2003), the entire disclosure of which is incorporated herein by reference for all purposes.

To reduce the computation load in determining the mapping function in one embodiment, principal component analysis (“PCA”) may be applied, such as described in Bai Z J, Demmel J, Dongarra J, Ruhe A, and Vorst H V D, “Templates for the solution of algebraic eigenvalue problems: A practical guide,” Society for Industrial and Applied Mathematics (2000), the entire disclosure of which is incorporated herein by reference for all purposes. PCA is a statistical model that decomposes high-dimensional data to a set of orthogonal vectors, allowing a compact representation of high-dimensional data to be estimated using lower-dimensional parameters. In particular, denoting B=(ΔT₁, ΔT₂, . . . ΔTᵥ₋₁), Σ=BB^{t}, ΔTᵢ=Tᵢ−T₀, and ΔT=T−T₀ for the neutral expression target To, the eigenvectors of Σ are
E=(ζ₀, ζ₁, . . . , ζ_{3U-1}), ∥ζᵢ∥=1,
where U is the total number of vertices in the three-dimensional face model. The projection of T using M main components to approximate it is as follows:

$$Δ T ≅ {\sum }_{j = 0}^{M - 1} {α}_{j} {ζ}_{j} ,$$

where the linear combination coefficients are αⱼ=ζⱼ^{t}ΔT. Usually the M is less than V after discarding the last principal components. For each viseme target, ΔTᵢ may be decomposed as the following linear combination by PC:

$$Δ {T}_{i} ≅ {\sum }_{j = 0}^{M - 1} {α}_{ij} {ζ}_{j} ,$$

where αᵢⱼ=λⱼ^{t}ΔTᵢ. The coordinates of ΔTᵢ under the orthogonal basis {ζᵢ}₀^{M-1} are (αᵢ₀ αᵢ₁ . . . α_{iM-1})^{t}. From these two equations,

$$Δ T = {\sum }_{i = 0}^{V - 1} {w}_{i} Δ {T}_{i} ≅ {\sum }_{j = 0}^{M - 1} {\sum }_{i = 0}^{W - 1} {w}_{i} {α}_{ij} {ζ}_{j} ≅ {\sum }_{j = 0}^{M - 1} {\hat{α}}_{j} {ζ}_{j} ,$$

with

$${\hat{α}}_{j} ≡ {\sum }_{i = 0}^{V - 1} {w}_{i} {α}_{ij} .$$

After the shape-blending coefficients are estimated, the mapping function is obtained. Thus, the motions of the three-dimensional trajectories of facial markers are mapped onto the motions of vertices in the three-dimensional face model.

d. Time Warping: In some embodiments, motions at the juncture of two divisemes may be blended. The time scale of the original motion-capture data may be warped in such embodiments onto the time scale of the target speech used to drive the animation. For instance, if the duration of a phoneme in the target speech stream ranges over the interval [τ₀, τ₁], and the time interval for its corresponding diviseme in motion-capture data ranges over the interval [t₀, t₁], an appropriate time warping may be achieved with the time-warping function

$$t ( τ ) = {t}_{0} + \frac{τ - {τ}_{0}}{{τ}_{1} - {τ}_{0}} ( {t}_{1} - {t}_{0} ) .$$

In this way, the time interval is transformed into [τ₀, τ₁] so that the motion trajectory defined in [t₀, t₁] is embedded within [τ₀, τ₁]. Furthermore, the motion vector m(t) is transformed into the final time-warped motion vector n(τ) as n(τ)=m(t(τ)).

e. Motion Vector Blending: In some embodiments, the blending of the juncture of two adjacent divisemes in a target utterance is used to concatenate the two divisemes smoothly. For two divisemes denoted by Vᵢ=(p_{i,0}, p_{i,1}) and Vᵢ₊₁=(p_{i+1,0}, p_{i+1,1}) respectively, where p_{i,0} and p_{i,1} represent the two visemes in Vᵢ, p_{i,1} and p_{i+1,0} are different instances of the same viseme and define the juncture of Vᵢ and Vᵢ₊₁. For a speech segment in which the duration of the two visemes p_{i,1} and p_{i+1,0} are embedded into the interval [τ₀, τ₁] the time-warping functions discussed above may be used to transfer the time intervals of the two visemes into [τ₀, τ₁]. In addition, their transformed motion vectors may be denoted by
n_{i,1}(τ)=m_{i,1}(t(τ))
n_{i+1,1}(τ)=m_{i+,1}(t(τ)),
so the time domains of the two time-warped motion vectors are the same. The juncture of the two divisemes is thus derived by blending the two time-aligned motion vectors as
hᵢ(τ)=fᵢ(τ)n_{i,1}(τ)+(1−fᵢ(τ))n_{i+1,1}(τ).
The blending functions fᵢ(τ) may be chosen as parametric rational Gⁿ continuous blending functions:

$${b}_{n , u} ( t ) = \frac{{μ ( 1 - t )}^{n + 1}}{{μ ( 1 - t )}^{n + 1} + ( 1 - μ ) {t}^{n + 1}} , t ∈ [ 0 , 1 ] , μ ∈ ( 0 , 1 ) , n \geq 0.$$

In alternative embodiments, other types of blending functions may be used, such as polynomial blending functions. For instance, p(t)=1−3t²+2t³ is a suitable C¹ blending function p(t)=1−(6t⁵−15t⁴+10t³) is a suitable C² blending function. The blending function acts like a low-pass filter to smoothly concatenate the two divisemes when defined

$${f}_{i} ( τ ) ≡ {b}_{n , u} ( \frac{τ - {τ}_{0}}{{τ}_{1} - {τ}_{0}} ) .$$

f. Trajectory Synthesis as a Search Graph: There are a variety of embodiments in which there is a set of diviseme motion sequences for each diviseme, i.e. for which there are multiple instances of lip motions for each diviseme. In such embodiments, there may be different methods for concatenating the sequences in different embodiments.

i. Lip-Motion Graph: In one embodiment, the collection of diviseme motion sequences may be represented as a directed graph, such as shown in FIG. 7. Each diviseme motion example is denoted as a node in the graph, with the edge representing 1 5 transition from one diviseme to another. In this way, the optimal path in the graph may constitute a suitable concatenation of visible speech. Determining the optimal path may be performed by defining an optimal objective function to measure a degree of smoothness of the synthetic visible speech. For instance, the objective function may be defined to minimize the following degree of smoothness of the motion trajectory:

$${min}_{path} {\int }_{{t}_{0}}^{{t}_{1}} {‖ {V}^{( 2 )} ( t ) ‖}^{2} ⅆ t ,$$

where V(t) is the concatenated lip motion for an input text.

In a particular embodiment, solution of the optimal problem illustrated by FIG. 7 is simplified by defining a target cost function and a concatenation cost function. The target cost is a measure of distance between a candidate's features and desired target features. For example, if observation data about lip motion are provided, the target features might be lip height, lip width, lip protrusion and speech features, and the like. The target cost corresponds to the node cost in the graph, while the concatenation cost corresponds to the edge cost. The concatenation cost thus represents the cost of the transition from one diviseme to another. After the two cost functions have been defined, a Viterbi algorithm may be used in one embodiment to compute the optimal path. When the basic unit is the diviseme, the primary coarticulation may be modeled very well. For an input text, its corresponding phonetic information is known. In instances where no observation of lip motion is provided for the target specification, the target cost may be defined to be zero. Such definition may also reflect the fact that spectral information extracted from the speech signal may not provide sufficient information to determine a realistic synthetic visible speech sequence. For instance, the acoustic features of the speech segments /s/ and /p/ in an utterance of the word “spoon” are quite different from those for the phoneme /u/, whereas the lip shapes of /s/ and /p/ in this utterance are very similar to the phoneme /u/.

In some embodiments, the concatenation cost may be defined as a degree of smoothness of visual features at the juncture of the two divisemes. For example, for a diviseme sequence Vᵢ=(p_{i,0}=1, 2, . . . , N, the concatenation cost of units Vᵢ=(p_{i,0}, p_{i,1}) and Vᵢ₊₁=(p_{i+1,0}, p_{i+1,1}) may be
C_{V}_{ᵢ}_{-V}_{ᵢ₊₁}=∫∥hᵢ⁽²⁾(τ)∥²dτ, i=1, 2, . . . , N,
where Vᵢ is a diviseme lip-motion instance, Vᵢ ∈ Eᵢ, and Eᵢ is the set of diviseme lip-motion instances. The specific definition of hᵢ(t) above and the use of the integral of hᵢ⁽²⁾(t) allows the degree of smoothness of the function at the juncture of the two divisemes to be measured. The total cost is thus given by

$$C = {\sum }_{i = 1}^{N - 1} {C}_{{V}_{i} - {V}_{i + 1}} .$$

In these embodiments, the visible speech unit concatenation becomes the following optimization problem:

$${min}_{( {V}_{1} , {V}_{2} , … , {V}_{N} )} C = {\sum }_{i = 1}^{N - 1} {C}_{{V}_{i} - {V}_{i + 1}} ,$$

subject to the constraints Vᵢ ∈ Eᵢ.

ii. Viterbi Search: In a specific embodiment, this optimization problem is solved by searching the shortest path from the first diviseme to the last diviseme, with each note corresponding to a diviseme motion instance. The distance between two nodes is the concatenation cost, and the shortest distance may be calculated in an embodiment using dynamic programming. If Vᵢ ∈ Eᵢ is a node in stage I and d(Vᵢ) is the shortest distance from node Vᵢ ∈ Eᵢ to the destination V_{N}, d(V_{N})=0 and

$$d ( {V}_{i} ) = {min}_{{V}_{i + 1} ∈ {E}_{i + 1}} \{ {C}_{{V}_{i} - {V}_{i + 1}} + d ( {V}_{i + 1} ) \} , i = N , N - 1 , … , 1$$

$${V}_{i + 1}^{*} = {arc min}_{{V}_{i + 1} ∈ {E}_{i + 1}} \{ {C}_{{V}_{i} - {V}_{i + 1}} + d ( {V}_{i + 1} ) \} ,$$

where C_{V}_{ᵢ}_{-V}_{ᵢ₊₁} denotes the concatenation cost from node Vᵢ to node Vᵢ₊₁. This defines a recursive set of equations that permits the problem to be solved.

g. Smoothing: In still other embodiments, the concatenated trajectory may be smoothed. In one such embodiment, the smoothed trajectory is determined by a trajectory smoothing technique based on spline functions. The synthetic trajectory of one component of a parameter vector is denoted as f(t), with the trajectory obtained in one embodiment by the concatenation approach described above. If the samples are denoted by fᵢ=f(tᵢ), t₀<t₁< . . . <t_{L}, a smoother curve g(t) that fits all the data may be found my minimizing the following objective function:

$${\sum }_{i = 0}^{L} {{ρ}_{i} ( {g}_{i} - {f}_{i} )}^{2} + {\int }_{{t}_{0}}^{{t}_{L}} {( {g}^{( 2 )} ( t ) )}^{2} ⅆ t ,$$

where ρᵢ is the weighting factor to control each gᵢ=g(tᵢ) for each target fᵢ. The solution to this equation is
g=(I+P⁻¹C¹C)⁻¹f,
where I is a unit matrix,
f=(f₀, f₁, . . . , f_{L})¹,

$$A = \frac{1}{6} [ \begin{matrix}4 & 1 & & 0 \\ 1 & 4 & ⋰ & \\ & ⋰ & ⋰ & 1 \\ 0 & & 0 & 4\end{matrix} ] , C = [ \begin{matrix}1 & - 2 & 1 & & & 0 \\ & 1 & - 2 & 1 & & \\ & & ⋰ & & ⋰ & \\ 0 & & & 1 & - 2 & 1\end{matrix} ] , and$$

P=diag(ρ₀,ρ₁, . . . , ρ_{N}).
The control parameter ρᵢ depends on the phonetic information. A large value indicates that the smoothed curve tends to be near the value f(tᵢ) at time tᵢ, and vice versa. For labial or labial-dental phonemes, such as /p/, /b/, /m/, /f/, and /v/, the value ρᵢ may be set to large values to avoid having the smoothed target value gi be too far away from the actual target value f, which will not make the lips close to each other.

In other embodiments, other smoothing techniques may be used, such as the technique described in Ezzat T, Geiger G, and Poggio T, “Trainable video realistic speech animation,” in Proc. ACM SIGGRAPH Computer Graphics, pp. 388-398 (2002), the entire disclosure of which is incorporated herein by reference for all purposes.

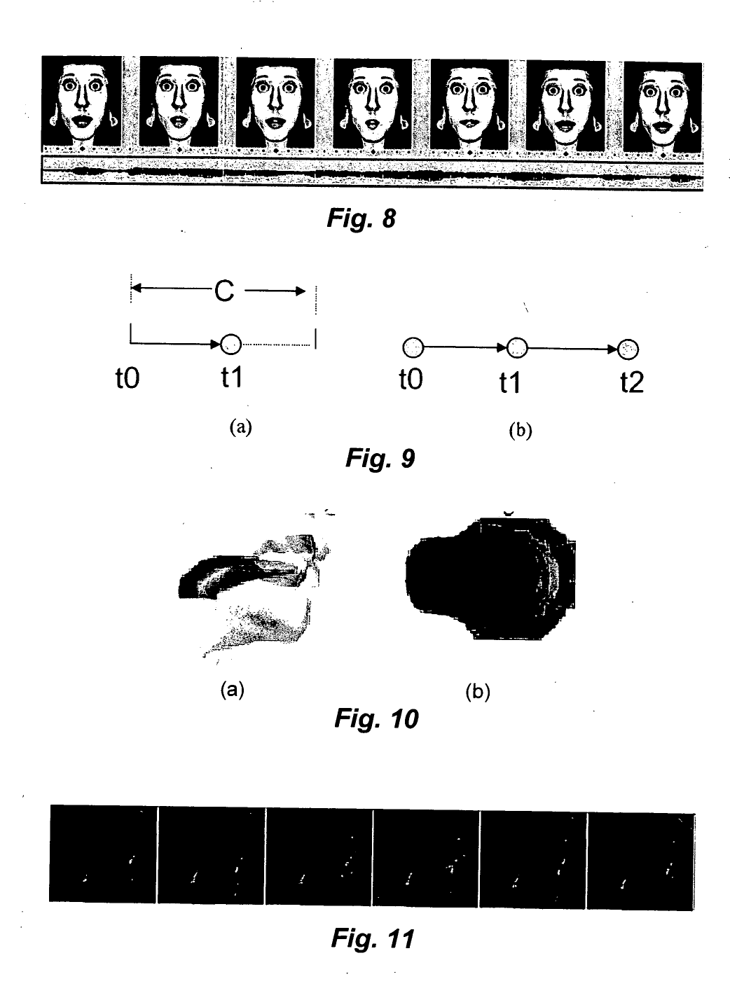

h. Audiovisual Synchronization: A variety of different techniques may be used in different embodiments for audiovisual synchronization. For instance, in one embodiment the Festival text-to-speech system may be used as described at http://www.cstr,ed.ac.uk/projects/festival, the entire disclosure of which is incorporated herein by reference for all purposes. Festival is also a diphone-based concatenative speech synthesizer that represents diphones by short speech wave files for transitions between the middle of one phonetic segment to the middle of another phonetic segment. In other embodiments, the SONIC speech recognizer in forced-alignment mode may be used as described in Pellom B and Hacioglu K, “Recent Improvements in the SONIC ASR System for Noisy Speech: The SPINE Task,” Proc. IEEE Int'l Conf. on Acoustics, Speech, and Signal Processing (ICASSP), Vol. 1, pp. 4-7 (2003), the entire disclosure of which is incorporated herein by reference for all purposes. To produce a visible speech stream synchronized with the speech stream, an animation engine comprised by the system may extract the duration of each diphone computed by such speech-aligner techniques. An example that illustrates the synchronization between audio and video signals is provided in FIG. 8.

The animation engine accordingly creates a diviseme stream that comprises concatenated divisemes corresponding to the diphones. The animation engine may load the appropriate divisemes into the diviseme stream by identifying corresponding diphones. In some instances, the duration of a diviseme may be warped to the duration of its corresponding diphone, such as when the speech signal is used to control the synchronization process. For instance, suppose that the expected animation frame rate is F per second and the total duration of the audio stream is T milliseconds. The total number of frames will be about 1+FT/1000, and the duration between two frames is C=1000/F milliseconds.

There are at least two approaches to synchronizing the visible speech and auditory speech that may be used in different embodiments. One such approach uses synchronization with a fixed frame rate, while the other such approach uses synchronization with maximal frame rate based on computer performance. The synchronization method for a fixed frame rate is illustrated in panel (a) of FIG. 9, and includes the following. First, the speech signal is played and a frame of image is rendered simultaneously. The start system time to for playing speech is collected, as is the time stamp t₁ when the rendering process for the image is completed. If t₁−t₀<C, the system waits for a time C−(t₁−t₀), and then repeats the process, but if t₁−t₀≧C, the process is repeated immediately.

The synchronization method with maximal frame rate for variable frame rate is illustrated in panel (b) of FIG. 9, and includes the following. The speech signal is played and a from of image rendered simultaneously. The start system time to for playing speech is collected, as is the time stamp t₁ when the rendering process for the image is completed. Subsequently, the animation parameters at time v=(t₁−t₀)/C are retrieved, and the process repeated. While this approach may produce a higher animation rate, the animation engine is computationally greedy and may use most of the CPU cycles.

4. Coarticulation Modeling of Tongue Movement

In some embodiments, the role of the tongue in visible speech perception and production may be accounted for. Some phonemes that are not distinguished by their corresponding lip shapes may be differentiated in such embodiments by tongue positions. This is true, for example, of the phonemes /f/ and /th/. In addition, a three-dimensional tongue model may be used to show positions of different articulators for different phonemes from different orientations using a semitransparent face to help people to learn pronunciation. Even though only a small part of the tongue is visible during most speech production, the information provided by this visible part may increase the intelligibility of visible speech. In addition, a tongue is highly mobile and deformable.

To illustrate such coarticulation modeling, a tongue target was designed, with tongue posture control being provided by 24 parameters manipulated by sliders in a dialog box. One exemplary three-dimensional tongue model is shown in FIG. 10, with part (a) showing a side view and part (b) showing a top view. According to embodiments of the invention, smoothing techniques are combined with heuristic coarticulation rules to simulate the tongue movement. The coarticulation effects of the tongue movement are different from those of lip movements. Some tongue targets may be completely reached, such as with the tongue up and down in /t/, /d/, /n/, and /l/; with the tongue between the teeth in /T/ thank and /D/ bathe; with the lips forward in /S/ ship, /Z/ measure, /tS/ chain, and /dZ/ Jane; and with the tongue back in /k/, /g/, /N/, and /h/. Other tongue targets may not be completely reached, allowing all phonemes to be categorized into two classes according to the criterion of whether the tongue target corresponding to the phoneme is or is not completely reached. Different smoothing parameters may be applied to simulate the tongue movement for the different categories.

In one embodiment, tongue movement is modeled using a kernel smoothing approach described in Ma J. Y. and Cole R., “Animating visible speech and facial expressions,” The Visual Computer, 20(2-3): 86-105 (2004), the entire disclosure of which is incorporated herein by reference for all purposes. In such embodiments, an observation sequence yᵢ=μ(xᵢ) is to be smoothed with {xᵢ}ᵢ₌₀ⁿ satisfying the condition 0=x₀<x₁<x₂< . . . <xₙ₋₁<xₙ=1. The weighted average of the observation sequence is used as an estimator of μ(x), which is referred to the “Nadaraya-Wastson estimator”:

$$μ ( x ) = {\sum }_{i = 0}^{n} {y}_{i} {w}_{i} ( x ) , where$$

$${\sum }_{i = 1}^{n} {w}_{i} ( x ) = 1 , \\ {w}_{i} ( x ) = {K}_{λ} ( x - {x}_{i} ) / {M}_{0} , and$$

$${M}_{0} = {\sum }_{i = 1}^{n} {K}_{λ} ( x - {x}_{i} ) .$$

For the tongue-movement modeling, the relationship between time t and x is expressed as

$$x = \frac{t - {t}_{0}}{{t}_{n} - {t}_{0}}$$

$${x}_{i} = \frac{{t}_{i} - {t}_{0}}{{t}_{n} - {t}_{0}} ,$$

where the interval [t₀, tₙ] represents a local window at frame or time t and n is the size of the window. When the sampling points {xᵢ}ᵢ₌₀ⁿ are from one speech segment, i.e. all values of {yᵢ}ᵢ₌₀ⁿ are equal; the morph target can be completely reached. When the sampling points are not from the same speech segment, the smoothed target value the weighted average of sampling points from different speech segments. Therefore, the target value at the boundary of two speech segments is smoothed according to the distributions of sampling points in the two speech segments. A tongue-movement sequence generated by this approach is illustrated with a sequence of panels in FIG. 11.
5. Multi-Units

a. Corpus: In some embodiments, a multi-unit approach is used, in which the database includes motion-capture data from a plurality of common words in addition to the divisemes. To illustrate such embodiments, motion-capture data were collected for about 1400 English words, in the form of 200 sequences of about seven words per sequence, at a motion-capture studio. The word sequences were recorded by a professional speaker and contained the most common single-syllable words occurring in spoken English, as well as multi-syllabic words containing the most common initial, medial, and final syllables of English. In general, one factor in the selection of words used in motion capture is their coverage of the most common syllables in the language.

To estimate the frequency of each syllable in English, a syllabification system was designed based on the Festival speech synthesis system as described at http://www.cstr.ed.ac.uk/projects/festival/. According to the phonetic information generated by the Festival system, several heuristic rules may be applied to design an algorithm to segment the syllables in a word. To illustrate the method, an English lexicon that contains about 64,000 words was input to the system, with the system automatically determining the syllables for each word and estimating the frequency of each syllable identified. These syllables may be classified based on their position in a word, i.e. with some in an initial position, some in a final position, and some in an intermediate position. In this illustration, the corpus was selected to include about 800 words that cover the syllables with high frequency, to include the 100 most common words in English, and to include 400 “words” that have no meaning but cover all divisemes in English.

The acquisition of the data in this multi-unit approach was thus similar to that described above, including methods for preprocessing the data to identify speech segments in a captured sequence, to estimate head pose, and the like, as described above.

b. Prototype Selection: The prototypes for the multi-unit approach may be selected as suggested above to represent typical lip-shape configuration. These prototypes serve as examples in designing corresponding prototypes in the target face model, which may be used to define mapping functions from the source face to the target space. Generally, the larger the number of prototypes that are used, the higher the accuracy of the mapping functions. This consideration is generally balanced against the fact that the amount of work necessary to design prototypes for the target face increases with the number of prototypes.

Once the number of prototypes has been determined, a K-means approach may be applied to select the prototypes. To apply the K-means clustering approach, the marker positions on the speaker's face are formed as a multidimensional vector. In this way, all motion capture data are represented by a set of vectors, with the K-means approach applied to the set of vectors to select a set of cluster centers. Since the cluster centers computed by the K-means algorithm may not coincide with actual captured data, the nearest vector in the captured data to the computed cluster centers may be selected as a prototype in the captured data. The distance metric between two vectors may be computed according to a variety of different methods, and in one embodiment corresponds to a Euclidean distance. In some embodiments, the centers of some clusters are selected as visemes to ensure that some visemes form part of the set of visual prototypes.

c. Retargeting Motion: There are several methods by which the mapping functions from the motion-capture data to a target face model may be determined. In one exemplary embodiment, this determination is made using radial basis-function networks (“RBFNs”) as described, for example, in Choi S W, Lee D, Park J H, Lee I B, “Nonlinear regression using RBFN with linear submodels,” Chemometrics and Intelligent Laboratory Systems, 65, 191-208 (2003), the entire disclosure of which is incorporated herein by reference for all purposes. The prototypes selected in the source face are denoted Sᵢ, i=0,1,2, . . . , m−1, Sᵢ ∈ E R^{3P}, where p is the number of the measured three-dimensional facial points on the speaker's lower face. The prototypes designed for the target face model are denoted Tᵢ, i=0,1,2, . . . , m−1, where Tᵢ={vᵢ₀,vᵢ₁, . . . , v_{iN-1}}^{t} with vᵢₖ=(xᵢₖ, yᵢₖ, zᵢₖ) equal to the three-dimensional coordinate of the kth vertex in the ith prototype. The total number of vertices in the target face model is denoted N so that Tᵢ ∈ R^{3N}.

The RBFN may be expressed in terms of the mapping function

$$f ( x ) = {\sum }_{j = 0}^{m - 1} {w}_{j} {h}_{j} ( x ) ,$$

where the basis functions are hⱼ(x)=exp(−∥x−Sⱼ∥²/r²) and the weighting coefficients {wⱼ} are to be determined. The learning examples may be denoted as {Sⱼ,uⱼ}ⱼ₌₀^{m}, where the vector Sⱼ is a prototype defined for the source face, and uⱼ is a component of the prototype Tⱼ defined for the target face. By denoting y≡(u₀, u₁, . . . uₘ₋₁)^{t}, w≡(w₀, w₁, . . . , wₘ₋₁)^{t}, and H≡(hⱼ(Sᵢ)) as the design matrix, the fitting error may be expressed as
e=y−Hw.
To find a robust solution of the coefficient w, the following squared-error is defined:
E=∥y−Hw∥²+λ∥w∥².
The second term on the RHS of this equation is a penalty term, with λ being a regularization parameter controlling the penalty level.

In one embodiment, the regularization parameter X is determined by using generalized cross-validation (“GCV”) as an objective function. Given an initial value of the parameter λ, the following equations are iterated until λ converges to a value:
γ=m−λtrA⁻¹;
A=H^{t}H+λI;
ŵ=A⁻¹H^{t}y;
ê=y−Hŵ;

$$λ = \frac{η}{m - γ} \frac{{\hat{e}}^{t} \hat{e}}{{\hat{w}}^{t} {A}^{- 1} \hat{w}} ;$$

and
η=tr(A⁻¹−λA⁻²).
The converged value is a local minimum of GCV. This procedure may be applied in some embodiments to different coordinates of all vertices in the target face model. With the coefficients determined, the mapping function f(x) defined above may be used for all vertices.

d. Data Compression: Each frame of motion-capture data may thus be mapped to a multidimensional vector in R^{3N}. Depending on the number of frames of motion, this may result in a large number of retargeted data from the motion-capture data. In some embodiments, this large amount of data is handled with a data-compression technique to allow access of the data in real time and to permit the data to be loading into a memory. In one embodiment, the PCA compression technique described above is used. In particular, an orthogonal basis is computed by using the retargeted multidimensional vectors. Then, a multidimensional vector representing a retargeted face model is projected on the basis set, with the projection coordinates used as a compact representation of the retargeted face model.

e. Concatenation: In some embodiments, a heuristic technique is used to identify units in the motion-capture data for phonetic specification. In one such embodiment, a graph search is used like the one described above in connection with FIG. 7. In particular, an input text is transcribed into a target specification that represents the phonetic strings corresponding to the input text. A concatenated cost function allows units in the graph to be determined for the target specification by minimizing the cost function as described above. Furthermore, in some embodiments that use multi-units, the trajectory-smoothing techniques described above may also be applied. Such trajectory smoothing applies smoothing control parameters associated with different phonemes so that the concatenated trajectory is smooth.

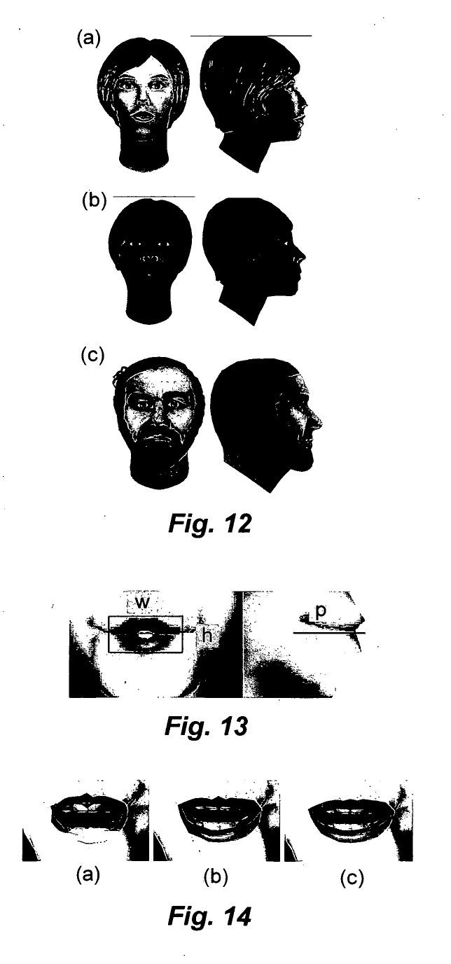

f. Model Adaptation: Embodiments of the invention may also use model-adaptation techniques in which morph targets designed for a three-dimensional generic model are adapted to a specific three-dimensional model derived from deforming the three-dimensional generic model. An automatic adaptation process may be used to save time in designing morph targets for the specific three-dimensional face model and to map the visible speech produced by the generic model to that of a specific three-dimensional face model. This is illustrated for one specific embodiment in FIG. 12, which shows three models in parts (a), (b), and (c) respectively identified for “Mami's model,” “Julie's model,” and “Pavarotti's model.” Mami's model may be considered to be a generic model with a set of designed morph targets such as facial expression morph targets and viseme targets, while Julie's three-dimensional model or Pavarotti's three-dimensional model may be derived by deformation of Mami's model.

For example, consider the adaptation of motions and morph targets of Mami's model (FIG. 12(a)) to those Julie's model (FIG. 12(b)). Because all vertex positions of the generic model and the specific model are known, an affine transformation may be constructed from the two sets of data, the affine transformation including at least one of a scaling transformation, a rotation transformation, and a translation transformation. Application of such an affine transformation thus adapts the motion of a generic model to a specific model. Merely by way of example, one triangular polygon in the generic model may be mapped to the same polygon in the specific model with the following interpolation algorithm:
yₚ=Ax, p=i, j, k
where yₚ=\tilde{v}ₚ−\tilde{v}_{C}, xₚ=vₚ−v_{C}, and \tilde{v}_{C} and v_{C} are the two reference points selected for the specific and generic models respectively. The reference points may be selected as the centers of the two polygon meshes defined by i,j, and k as vertex indices of the triangular polygon. The vertex position vectors are denoted \tilde{v}ₚ and vₚ respectively for the specific and generic model. The affine transformation matrix to be determined for the model adaptation is denoted A. Three equations in this transformation equation may thus define a unique affine transformation if the three vectors xₚ=vₚ−v_{C}(p=i, j, k) are not coplanar. This condition may be met for most triangular polygons; if the condition is not met, the triangular polygon is referred to herein as an “irregular” triangular polygon.

The affine transformation mapping a vertex of the generic model to its corresponding vertex in the specific model may be defined as a weighted average of affine transformations of triangular polygons neighboring the vertex:

$${\hat{A}}_{i} = \frac{{\sum }_{p ∈ {N}_{i}} {s}_{p} {A}_{p}}{{\sum }_{p ∈ {N}_{i}} {s}_{p}} ,$$

where Nᵢ denotes the set of triangular polygons neighboring vertex i. The area of triangular polygon p is denoted sₚ and the affine transformation associated with that polygon is denoted Aₚ. The affine transformation of the vertex i is denoted Âᵢ. After each affine transformation of each vertex has been determined, the targets or the lip motions of the generic model may be adapted to the specific model. Merely by way of example, suppose that the difference of the ith vertex position between a morph target and the neutral expression target of the generic model is Δvᵢ and that the difference of the ith vertex position between a morph target and the neutral expression target of the specific model is Δ\tilde{v}ᵢ. These vertex positions are related by the affine transformation of the vertex i,
Δ\tilde{v}ᵢ=AᵢΔvᵢ,
so that the ith vertex in the corresponding morph target in the specific model is
\tilde{\hat{v}}ᵢ=\tilde{v}ᵢ+AᵢΔvᵢ.

g. Evaluation: Embodiments of the invention thus permit an evaluation of the quality of synthesized visible speech. In one embodiment, referred to herein as an “objective” evaluation approach, objective evaluation functions are defined. One example of an objective evaluation function is the average error between normalized parameters in the source and target model. For instance, such parameters may include the normalized lip height, normalized lip width, normalized lip protrusion, and the like. The lip height h is the distance between two points on the centers of the upper lip and the lower lip; the lip width w is the distance between two points at the lip corners; and the lip protrusion is the distance between the middle point in the upper lip and a reference point selected near a jaw root. Examples of such measurements are illustrated in FIG. 13

To normalize the lip height, lip width, and lip protrusion, their maximum values are determined, and denoted as h^{t}ₘₐₓ, w^{t}ₘₐₓ, and p^{t}ₘₐₓ respectively for the retargeted face model and as h^{s}ₘₐₓ, w^{s}ₘₐₓ, and p^{s}ₘₐₓ respectively for the source model. The normalized lip height, lip width, and lip protrusion for the retarget face are thus
hₙ^{t}=h^{t}/hₘₐₓ^{t}
wₙ^{t}=w^{t}/wₘₐₓ^{t}
pₙ^{t}=p^{t}/pₘₐₓ^{t},
and for the source face are thus
hₙ^{s}=h^{s}/hₘₐₓ^{s}
wₙ^{s}=w^{s}/wₘₐₓ^{s}
pₙ^{s}=p^{s}/pₘₐₓ^{s}.
The average values of these normalized parameters may thus be determined for the retargeted face model as
\overline{h}ₙ^{t}=\overline{h}^{t}/hₘₐₓ^{t}
\overline{w}ₙ^{t}=\overline{w}^{t}/\overline{w}ₘₐₓ^{t}
\overline{p}ₙ^{t}=\overline{p}^{t}/\overline{p}ₘₐₓ^{t},
and for the source model as
\overline{h}ₙ^{s}=\overline{h}^{s}/\overline{h}ₘₐₓ^{s}
\overline{w}ₙ^{s}=\overline{w}^{s}/\overline{w}ₘₐₓ^{s}
\overline{p}ₙ^{s}=\overline{p}^{s}/\overline{p}ₘₐₓ^{s}.
To accommodate different geometric configurations in the source and retargeted face models, it is convenient to define the ratios
rₕ=\overline{h}ₙ^{s}/\overline{h}ₙ^{t}
r_{w}=\overline{w}ₙ^{s}/\overline{w}ₙ^{t}
rₚ=\overline{p}ₙ^{s}/\overline{p}ₙ^{t},
with the errors between the normalized lip parameters defined as
eₕ=hₙ^{s}−rₕhₙ^{t}
e_{w}=wₙ^{s}−r_{w}wₙ^{t}
eₚ=pₙ^{s}−rₚpₙ^{t}.
The average absolute differences of these parameters may thus define evaluation functions equal to the mean value of the errors
fₕ=<|eₕ|>
f_{w}=<|e_{w}|>
fₚ=<|eₚ|>

Another example of an objection evaluation function that may be used is some embodiments is a dynamic similarity coefficient of a time series of lip parameters between the source face model and the retargeted face model. Merely by way of example, the dynamic similarity coefficient of one parameter may be taken to be

$$S = \frac{\sum {x}_{t} {y}_{t}}{\sqrt{\sum {x}_{t}^{2} {y}_{t}^{2}}} ,$$

where {xₜ} and {yₜ} represent parameter time series in the source face model and in the retargeted face model. In certain embodiments, these parameters may comprise such parameters as the lip height, lip width, and lip protrusion defined in connection with FIG. 13.

In another embodiment, referred to herein as a “subjective” evaluation approach, subjective evaluation functions are used in evaluating the quality of synthesized visible speech. Embodiments that use subjective evaluation functions are generally more time-consuming and costly than the use of objective evaluation functions.

h. Exemplary Results: To illustrate embodiments that make use of multi-units, the inventors have implemented a visible speech synthesis such as described above, with motion-capture data mapped onto a Gurney's three-dimensional face mesh. In these investigations, the effect of regularization parameters λ was studied, and the effect of such parameters is illustrated in FIG. 14. When all regularization parameters λ are set to zero, the geometrical meshes computed from the RBFN mapping functions may create irregular meshes in the lip region in the target face model as illustrated in part (a) of FIG. 14. Increasing, the parameter λ may reduce the lip distortions, as shown in part (b) of FIG. 14 for λ=6, and with even less lip distortion as shown in part (c) of FIG. 14 for λ=50. Generally, too large values of λ are undesirable, however, because an increase in the regularization parameter λ may also reduce the accuracy of mapping functions.

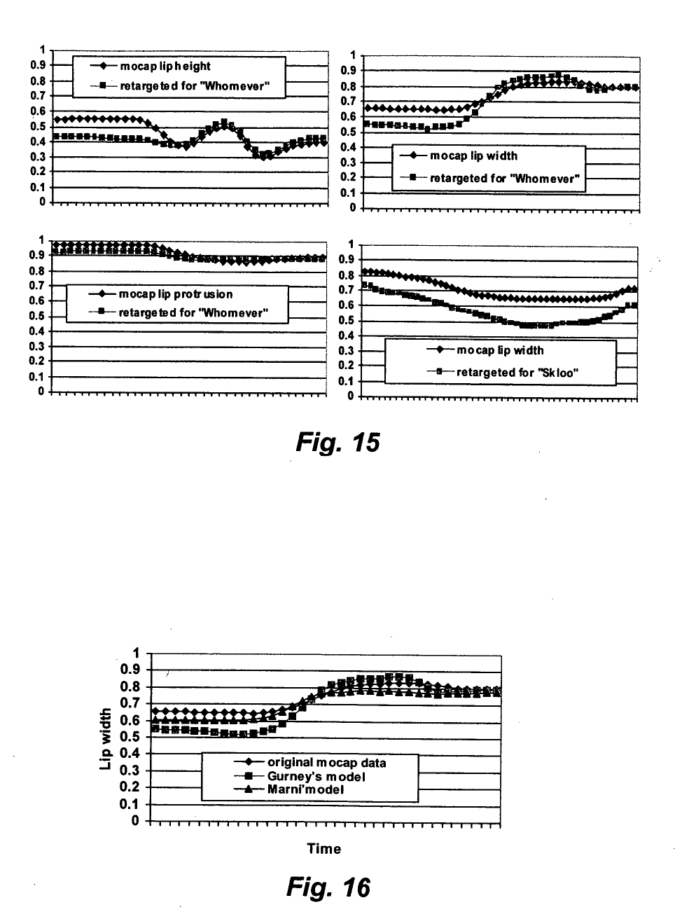

A specific experiment was conducted to use the objective functions described above in evaluating visible speech accuracy. In this experiment, about 60 k frames of retargeted face models were calculated, with average errors for lip height, lip width, and lip protrusion being 6.769%, 7.581%, and 2.39% respectively. The average dynamic similarity coefficient between these parameters in motion capture data in the retargeted face was about 0.986. The results of this experiment are illustrated in FIG. 15, which shows parameter curves for two words in the captured data, namely “whomever” and “skloo.” For the word “whomever,” it is evident that these computed parameters of the three-dimensional face model are matched to those computed from motion-capture data.

The average errors for lip height, lip width, and lip protrusion of Marni's model are 5.207%, 4.778%, and 2.21%, the absolute error reduction rates are 1.562%, 2.803%, and 0.18% respectively, and the relative reduction rates are 23.07%, 36.97%, and 7.56%. FIG. 16 demonstrates the lip-width curves of the word “whomever” generated by original motion capture data, Gurney's model, and Marni's model. It can be seen that the accuracy of the lip-width curve of Marni's model is more accurate than that of Gurney's model.

From FIG. 15, it is also evident that the lip width in the original motion-capture data is consistently larger than that in the retargeted face model for the word “skloo.” This does not mean that the accuracy of mapping functions is not high; the discrepancy is caused by the measurement errors in the original motion-capture data. Facial markers at lip corners are far from actual lip-corner position because markers on the actual lip-corner positions fall off easily during speech production as a result of large changes in muscle forces at lip corners, part curly during a change in lip shape from a neutral expression to the phoneme /u/.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for synthesis of visible speech in a three-dimensional face comprising:
extracting from a database a sequence of visemes, wherein each viseme of the sequence is associated with at least one of a plurality of phonemes;
mapping each viseme of the sequence onto the three-dimensional face; and
concatenating the sequence of visemes,
wherein each viseme of the sequence comprises a set of noncoplanar points defining a visual position on a face, the visual position corresponding to the at least one of a plurality of phonemes associated with such each viseme.

2. The method recited in claim 1, wherein each viseme of the sequence extracted from the database is comprised of previously captured three-dimensional visual motion-capture points from a reference face.

3. The method recited in claim 2, wherein the mapping step comprises mapping the motion-capture points to vertices of polygons of the three-dimensional face.

4. The method recited in claim 1, wherein:
the sequence of visemes includes a diviseme corresponding to a pairwise sequences of phonemes; and
the diviseme is comprised of a plurality of motion trajectories of the set of noncoplanar points.

5. The method recited in claim 4, wherein the mapping step includes use of a mapping function utilizing shape-blending coefficients to map the plurality of motion trajectories to the three-dimensional face.

6. The method recited in claim 4, wherein the concatenating step includes concatenating the sequence of visemes using a motion vector blending function.

7. The method recited in claim 4, wherein the concatenating step includes finding an optimal path through a directed graph representing the plurality of motion trajectories.

8. The method recited in claim 4, wherein the concatenating step includes use of a smoothing algorithm to smooth transition between the plurality of motion trajectories.

9. The method recited in claim 8, wherein the smoothing algorithm is a spline smoothing algorithm.

10. The method recited in claim 1, wherein the visual position on a face includes a tongue.

11. The method recited in claim 10, wherein the synthesis further comprises coarticulation modeling of the tongue.

12. The method recited in claim 1, wherein,
the sequence of visemes includes multi-units corresponding to a plurality of sequences of phonemes; and
the multi-units are comprised of a plurality of motion trajectories of the set of noncoplanar points.

13. The method recited in claim 1, wherein the database is further comprised of a plurality of motion trajectories of the set of noncoplanar points.

14. The method recited in claim 13, wherein the plurality of motion trajectories correspond to pairwise sequences of phonemes.

15. The method recited in claim 13, wherein the plurality of motion trajectories are computed based on previously captured three-dimensional visual motion-capture points.

16. A computer-readable storage medium having a computer-readable program embodied therein, which includes instructions for:
extracting from a database a sequence of visemes, wherein each viseme of the sequence is associated with at least one of a plurality of phonemes;
mapping each viseme of the sequence onto a three-dimensional face; and
concatenating the sequence of visemes,
wherein the each viseme of the sequence comprises a set of noncoplanar points defining a visual position on a face, the visual position corresponding to the at least one of a plurality of phonemes associated with such each viseme.

17. The computer-readable storage medium having a computer-readable program of claim 16, wherein the database is further comprised of a plurality of motion trajectories of the set of noncoplanar points.

18. The computer-readable storage medium having a computer-readable program of claim 16, wherein,
the sequence of visemes includes divisemes corresponding to pairwise sequences of phonemes; and
the divisemes are comprised of a plurality of motion trajectories of the set of noncoplanar points.

19. The computer-readable storage medium having a computer-readable program of claim 16, wherein,
the sequence of visemes includes multi-units corresponding to a plurality of sequences of phonemes; and
the multi-units are comprised of a plurality of motion trajectories of the set of noncoplanar points.

20. A method for synthesis of visible speech in a three-dimensional face comprising:
extracting from a database a plurality of sets of vectors, wherein each set of vectors of the plurality corresponds to movement of a set of noncoplanar points defining a visual position on a face, the movement associated with a sequence of phonemes;
mapping each vector of the plurality of sets onto points of the three-dimensional face; and
concatenating the sets of vectors of the plurality.

21. The method recited in claim 20, wherein each vector of the plurality of sets corresponds to visual motion-capture samples obtained by recording positions of a marker on a face of a subject speaking a corpus of text including the sequence of phonemes.

22. The method recited in claim 20, wherein the concatenating step includes concatenating the sets of vectors of the plurality using a motion vector blending function.

23. The method recited in claim 20, wherein the concatenating step includes finding an optimal path through a directed graph representing the sets of vectors of the plurality.

24. The method recited in claim 20, wherein the concatenating step further comprises use of a smoothing algorithm to smooth the transition between the sets of vectors of the plurality.
